(19) United States
(12) Patent Application Publication
(10) Pub. No.: US 2006/0212395 A1
(43) Pub. Date: Sep. 21, 2006

(54) Method and system for computerized administration of affinity programs for purchasing copyrighted computer files

(76) Inventors: Howard Edward Winklevoss JR., Greenwich, CT (US); Cameron Howard Winklevoss, Greenwich, CT (US); Tyler Howard Winklevoss, Greenwich, CT (US)

Correspondence Address: Richard C. Irving;Law Office of Thomas M. Isaacson, 850 Lindy Lane, Huntingtown, MD, 20639, US

(21) Appl. No.: 11/080,778

(22) Filed: Mar. 15, 2005

(51) Int. Cl. G06Q 99/00

(52) U.S. Cl. 705/50

(57) ABSTRACT

An apparatus and a method are provided. A request for a file is received. A determination is made regarding whether the file is a copyrighted file. A cost of the file is determined. Whether a requesting user has a sufficient balance in at least one affinity group account to cover the cost of the file is determined. The at least one affinity group account is debited by an amount of the cost when the requesting user has the sufficient balance in the at least one affinity group account. The requested file is shared with a processing device associated with the requesting user.

### BACKGROUND OF THE INVENTION

1. Field of the Invention

The present invention is directed to a method and system for linking affinity programs to the purchase of computer files and, more particularly, to a method and system for purchasing copyrighted computer files.

2. Introduction

Affinity programs, sometimes referred to as loyalty programs, were created when various airlines first began offering credits toward free tickets based on the number of miles the traveler accumulated with the airline in question. Affinity programs have evolved from this beginning to a variety of forms today. For example, a number of colleges have instituted affinity programs whereby, each time an alumnus purchases various consumer items, the college receives a small percentage of the purchase price as a contribution to the school's alumni fund. In another embodiment of affinity programs, some banks offer credit cards which, when used to purchase various items, provide a financial credit to the credit card holder. There are other variations of these affinity or loyalty programs. For example, rather than accumulating credits, either in the form of “mile credits” in the case of airlines or “financial credits” in the case of bank credit cards, some loyalty programs simply provide a small percentage discount on the items purchased by the affinity member. The financial credit or discounts, depending on the variation of the affinity program, are usually in the range of five percent of the purchase amount, but can run as high as ten percent for some retailers and/or restaurants.

The more general affinity programs have essentially two components; 1) individuals who are members of an affinity group, such as alumni of a given college or holders of a bank's credit cards, and 2) a group of retailers and/or restaurants that have agreed to participate in an affinity program by offering either a financial credit to the purchaser or a discount on the purchase of their goods and services. The objective of a successful affinity program is to attract a large number of participants and a large number of retail establishments. Both components (participants and retailers) need to be large in order for the more general affinity program to be successful.

A development currently unrelated to affinity programs is widespread file sharing among computer users, and in particular, the sharing of copyrighted files among computer users. There are generally two embodiments of such file sharing. One approach is for a given organization to create a central database of all the files that users are willing to share. Then, when other computer users request a given file, such as a copyrighted song, a central server matches a user who requested a file with a user who has the file, and the file is downloaded from the matching user. This approach, which was pioneered by Napster, is now prohibited by federal laws to the extent that the sharing involves copyrighted files. Enforcing this law, however, is difficult. There are still a number of centralized file sharing web sites that offer file sharing, with many of the files involving copyrighted files. Some organizations that own a large amount of copyrighted material, such as songs, are attempting to enforce this law by filing thousands of lawsuits against computer users who have obtained copyrighted files. These suits are generally settled with the perpetrator paying a settlement fee of several thousands dollars, with such settlement fees being used to fund the filing of additional law suits. At this writing, nearly 10,000 such lawsuits have been filed.

A second embodiment of file sharing is decentralized peer-to-peer (P2P) networks. Under this arrangement, computer users make available (or offer) various files on their system for sharing purposes and instead of connecting to a central server, the computer users connect to each other. When another user requests one of the available files, the request is processed by another user's computer, thereby avoiding the “central server” methodology. It is expected that the P2P file sharing arrangement, when it involves copyrighted material, will also be the subject of law suits at some future date.

In response to the wide use of sharing copyrighted files, particularly copyrighted songs, the owners of such material have made arrangements with various computer-based vendors, such as, for example, ITunes®, which is a registered trademark and service mark of Apple Computer Corp. of Cupertino, Calif., as well as other vendors, to sell their songs for a relatively modest amount, and in many cases as low as one dollar per song. Their goal is to entice computer users to “become legal” and purchase copyrighted material at a modest price, hoping to stop the free sharing of copyrighted materials. But human nature, being what it is, makes purchasing several hundred (or in many cases, several thousand songs) for several hundred dollars (or several thousand dollars) a difficult decision—especially for younger computer users—when such copyrighted files are available free through various file sharing methodologies, albeit with some risk of “getting caught”.

### SUMMARY OF INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

In a first aspect of the invention, a method is provided. A request for a file is received. A determination is made regarding whether the file is a copyrighted file. A cost of the file is determined. Whether a requesting user has a sufficient balance in at least one affinity group account to cover the cost of the file is determined. The at least one affinity group account is debited by an amount of the cost when the requesting user has the sufficient balance in the at least one affinity group account. The requested file is shared with a processing device associated with the requesting user.

In a second aspect of the invention, a machine-readable medium having instructions, recorded thereon, for a processor is provided. The machine-readable medium includes instructions for receiving a request for a file, instructions for determining whether the file is a copyrighted file, instructions for determining a cost of the file, instructions for determining whether a requesting user has a sufficient balance in at least one affinity group account to cover the cost of the file, instructions for debiting the at least one affinity group account by an amount of the cost when the requesting user has the sufficient balance in the at least one affinity group account, and instructions for sharing the requested file with a processing device associated with the requesting user.

In a third aspect of the invention, an apparatus is provided. The apparatus includes a processor and storage for holding data and instructions for the processor. The apparatus is configured to receive a request for a file, determine whether the file is a copyrighted file, determine a cost of the file, determine whether a requesting user has a sufficient balance in at least one affinity group account to cover the cost of the file, debit the at least one affinity group account by an amount of the cost when the requesting user has the sufficient balance in the at least one affinity group account, and share the requested file with a processing device associated with the requesting user.

### BRIEF DESCRIPTION OF THE DRAWING

In order to describe the manner in which the above-recited embodiments and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system for executing implementations consistent with the principles of the invention;

FIG. 2 is a functional block diagram that illustrates an exemplary processing system that may be used to implement a server and/or a user's processing system shown in FIG. 1; and

FIGS. 3-5 are a flowcharts of exemplary processes that may be implemented in embodiments consistent with the principles of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

### Exemplary System

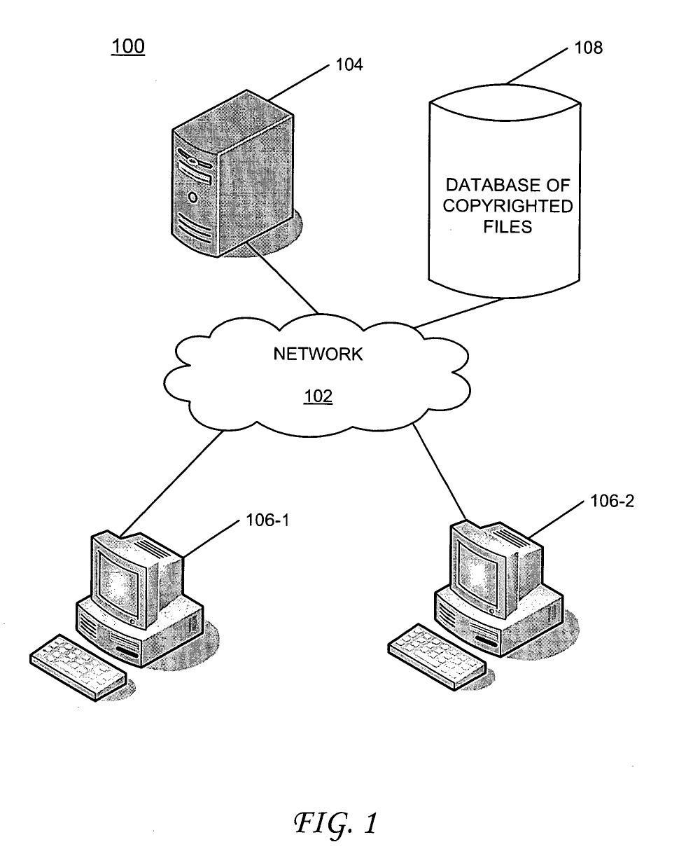

FIG. 1 illustrates an exemplary system 100 in which implementations consistent with the principles of the invention may reside. System 100 may include a network 102, a server 104, user processing devices 106-1, 106-2 (collectively referred to as 106), and a database of copyrighted work 108.

Network 102 may be a packet switching network, such as the Internet, or may be any other type of network, such as, for example, an Ethernet network, an Asynchronous Transfer Mode (ATM) network, an optical network, as well as other types of networks Further, network 102 may include a Local Area Network (LAN), a Wide Area Network (WAN), or a combination of networks.

Server 104 may be configured to process requests from users for computer files. In some implementations consistent with the principles of the invention, the computer files may reside in storage, such as a database, that is local to server 104. In other implementations consistent with the principles of the invention, the computer files may reside in one more remote storage devices or databases.

Processing systems 106 may include processing devices, such as personal computers, or handheld processing devices, such as, for example, an MP3 player, a Personal Data Assistant (PDA) or other processing device. Processing systems 106 may execute an application that permits a user at a processing device 106-1, 106-2 to request and receive computer files. In some implementations consistent with the principles of the invention, the application may be an Internet Browser, such as for example, Internet Explorer available from Microsoft Corporation of Redmond, Wash.

Database 108 may include computer files, such as copyrighted works or non-copyrighted works, for downloading to processing systems 106. In some implementations consistent with the principles of the invention, one or more databases of copyrighted files may be remotely located. In other implementations, one or more databases may be collocated with server 104.

The system shown in FIG. 1 is exemplary and may include more or fewer components than shown in FIG. 1. For example, system 100 may include multiple servers 104 or multiple databases 108 and may include more than two processing systems 106.

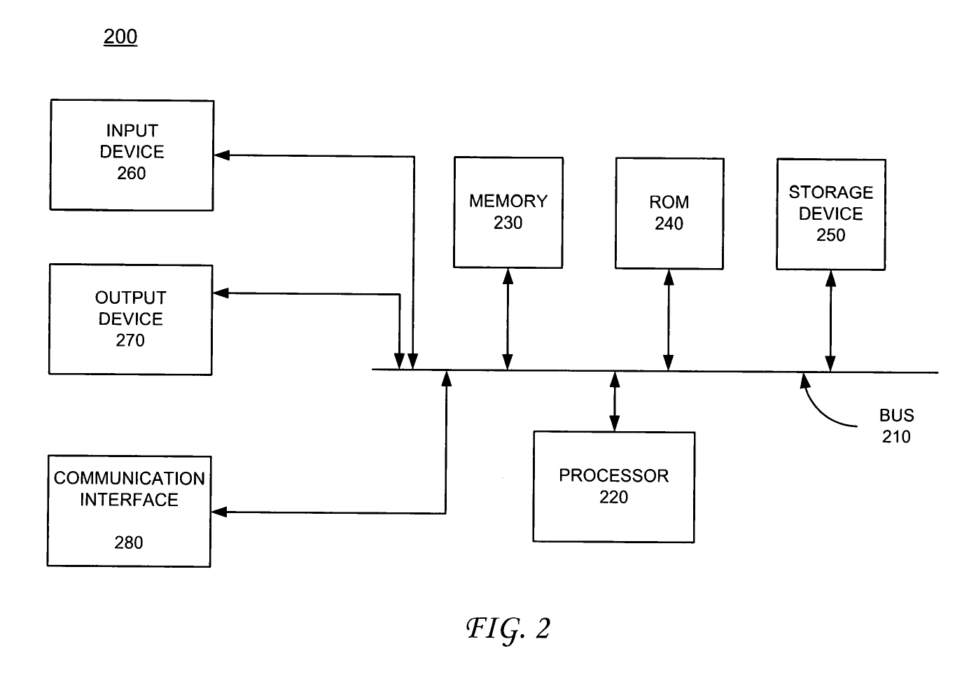

FIG. 2 is a functional block diagram of an exemplary processing system 200 that may be used to implement embodiments of server 104 and/or processing systems 106. System 200 may include a bus 210, a processor 220, a memory 230, a read only memory (ROM) 240, a storage device 250, an input device 260, an output device 270, and a communication interface 280. Bus 210 may permit communication among the components of system 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to system 200, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive. Communication interface 280 may include any transceiver-like mechanism that enables system 200 to communicate via a network. For example, communication interface 280 may include a modem, or an Ethernet interface for communicating via a local area network (LAN). Alternatively, communication interface 180 may include other mechanisms for communicating with other devices and/or systems via wired, wireless or optical connections.

System 200 may perform such functions in response to processor 220 executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

### Exemplary Operation

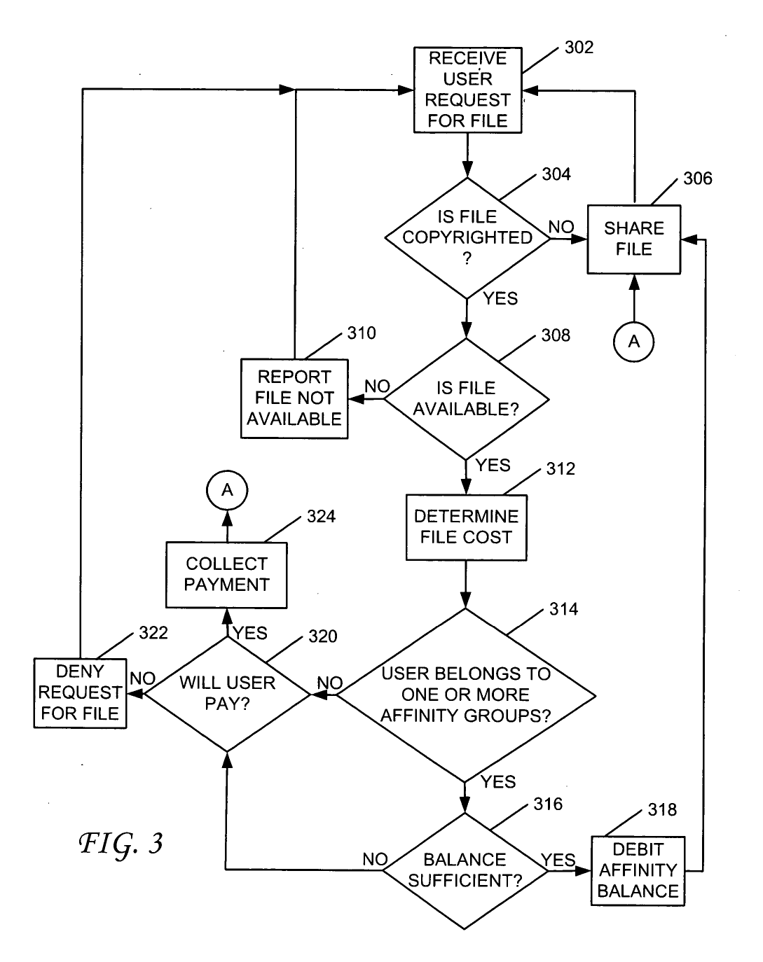

FIG. 3 is a flowchart that illustrates exemplary operation of an implementation consistent with the principles of the invention. First, as a result of a user initiating a request from user's processing system 106-1 for a computer file, server 104 may receive the request via network 102 (act 302) and may determine whether the requested file is copyrighted (act 304). Server 104 may determine whether the requested file is copyrighted by accessing a database having a list of copyrighted works, by searching for the requested file over a network, such as the Internet, by using, for example, a search engine, or by a number of different methods.

If server 104 determines that the requested file is not copyrighted, then the file may be shared with the requesting user (act 306). This may be done in a number of different ways. For example, in one implementation consistent with the principles of the invention, server 104 may have access to a remote or local database of files and may download the requested file to processing system 106-1. In another implementation consistent with the principles of the invention, server 104 may access a directory of users willing to share files. Server 104 may request the file from, for example, processing system 106-2 belonging to another user, and after receiving the requested file, may then download the file to the requesting user's processing system 106-1. In a third implementation consistent with the principles of the invention, server 104 may access a directory of users willing to share files and may obtain an address of a sharing user's processing system 106 and a name of the file. Server 104 may pass this information to the requesting user's processing system 106-1, which may then establish a connection to processing system 106-2 of the sharing user and may directly request and receive the file from the sharing user's processing system 106. In a fourth application, server 104, may access a directory of users willing to share files and may obtain an address of a sharing user's processing system 106 and a name of the file. Server 104 may then send an address of the requesting user's processing system 106-1, along with the name of the requested file to the sharing user's processing system 106-2. Processing system 106-2 of the sharing user may then establish a connection, such as for example, a peer-to-peer (P2P) connection, with processing system 106-1 of the requesting user and may download the requested file to processing system 106-1.

If, at act 304, server 104 determines that the request file is a copyrighted file, then server 104 may determine whether the requested file is available (act 308). In implementations consistent with the principles of the invention, server 104 may determine availability of the file by accessing a list of copyrighted files, which may include an availability indicator. In other implementations, server 104 may access a database of copyrighted files to determine availability. If server 104 determines that the copyrighted file is not available, then server 104 may send a message to processing system 106-1 to inform the user that the requested file is not available (act 310).

If the copyrighted file is available, then server 104 may determine the cost of the file (act 312). Cost information may be included in a list of available files or in one or more databases of copyrighted files. Next, server 104 may determine whether the requesting user is a member of one or more affinity groups (act 314). In some implementations consistent with the principles of the invention, affinity information may be stored in a user database. In such an implementation, the requesting user may be prompted to enter identifying information, such as a previously defined user ID and password. After authenticating the identifying information, server 104 may access one or more databases corresponding to the affinity group membership of the requesting user in order to access the user's affinity credit data.

Server 104 may then determine whether the requesting user has a sufficient affinity credit balance to pay for the copyrighted file (act 316). The affinity credit may be available from one or more affinity memberships, or if no one affinity membership has sufficient credit, a combination of credits from a group of affinity memberships may be used, assuming that the combination of credits is sufficient to pay for the file. If sufficient affinity credit exists, then server 104 may debit the affinity credit from the one or more affinity memberships (act 318). The file may then be shared or made available to processing device 106-1 of the requesting user (act 306).

If, at act 314, server 104 determines that the user does not belong to any affinity groups or, at act 316, server 104 determines that that the user's balance from one or more affinity groups is not sufficient, then server 104, may determine whether the user is willing to pay the cost of the file (act 320). Sever 104 may determine the user's willingness to pay by accessing a database of predefined user information, may send a message to processing system 106-1 requesting the user to provide payment information, or by any other suitable method. If server 104 determines that the user is not willing to pay, then server 104 may send a message to processing system 106-1 indicating that the request is denied (act 322). Otherwise, server 104 may collect payment information (act 324) by prompting the user to enter the payment information or, alternatively, by accessing predefined payment information stored in a database of user information.

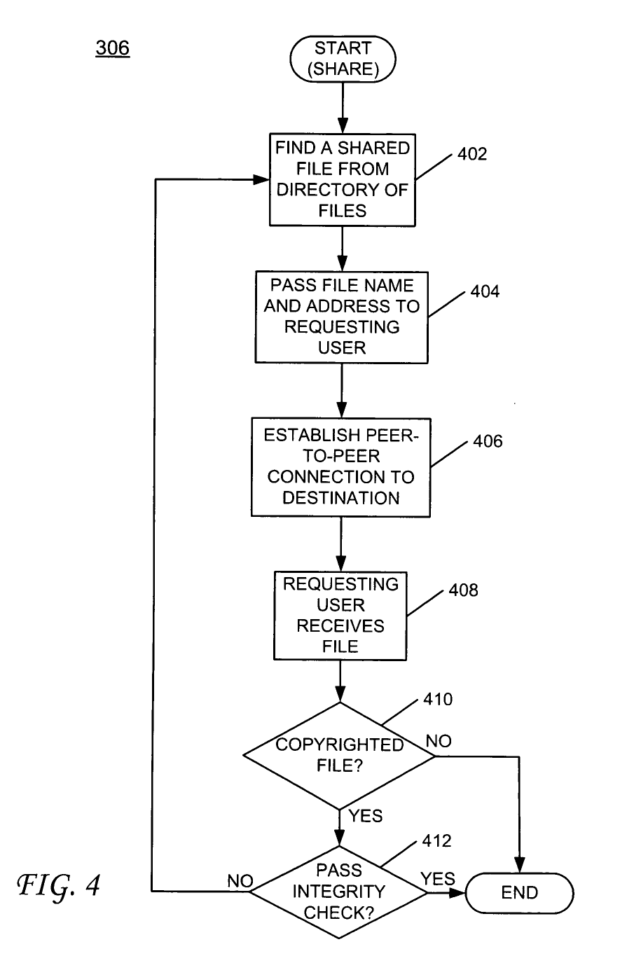

FIG. 4 illustrates a flowchart of an exemplary process for sharing or making a file available. This process corresponds to one implementation of act 306 of FIG. 3. The process may begin with server 104 searching a directory of files for the requested file (act 402). After finding the requested file, server 104 may obtain a name of the file and an address of processing device 106-2 of a sharing user (a user who has the file on his/her processing device and is willing to share the file). Server 104 may pass the file name and address to processing device 106-1 of the requesting user (act 404). Processing device 106-1 may then establish a connection, for example a peer-to-peer (P2P) connection, to processing device 106-2, corresponding to the address (act 406), and may request the file. Processing device 106-1 of the requesting user may then receive the file from processing device 106-2 of the sharing user via network 102.

Processing device 106-1 of the requesting user may then determine whether the file is a copyrighted file (act 410). In some implementations consistent with the principles of the invention, copyright status of the requested file may be obtained by server 104 from the directory of files. If the file is not a copyrighted file, the process may end. Otherwise, processing device 106-1 of the requesting user may perform an integrity check of the received file (act 412).

In one implementation consistent with the principles of the invention, an integrity check code may be included with the file sent to processing device 106-1 of the requesting user. The integrity check code may be for example, a checksum or a message digest code, such as an MD5 (Message Digest 5) code, which is a well-known message digest algorithm, or any other suitable code. If the received file passes the integrity check, then the process is completed. Otherwise, server 104 may be informed that the file at processing system 106-2 of the sharing user is corrupted and information regarding another processing system 106-n of another sharing user may be obtained and passed to processing system 106-1 of the requesting user (acts 402-404).

In another implementation consistent with the principles of the invention, server 104 may obtain the requested copyrighted or non-copyrighted file from a local or remote database and may send the requested file to processing device 106-1 of the requesting user. In such an implementation, processing device 106-1 of the requesting user may not perform an integrity check on the received file.

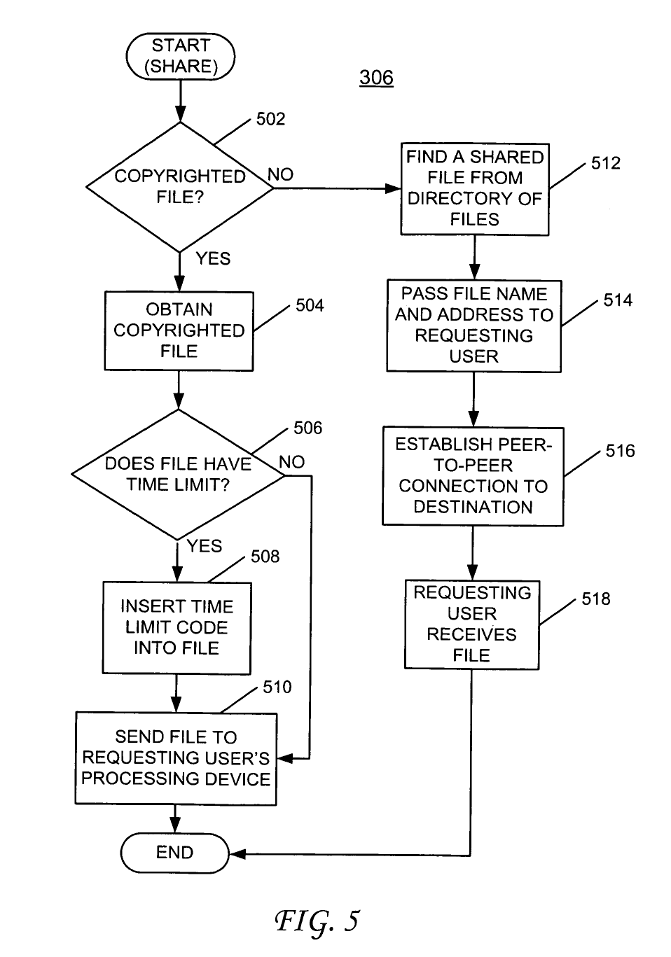

In some implementations consistent with the principles of the invention, the requesting user may rent the file for a specific period of time, such as for example, one day, one week, or some other time period. FIG. 5 is a flowchart of an exemplary process of act 306 of FIG. 3 that may be used in such implementations.

Server 104 may determine whether the requested file is a copyrighted file (act 502). If the file is a copyrighted file, then server 104 may obtain the file from a remote or local database (act 504). Server 104 may then determine whether a time limit restriction is associated with the file (act 506). If the file has a time limit restriction, as may be indicated in the database, then server 104 may insert a time limit indicator into the file (act 508). The time limit indicator may indicate existence of a time limit restriction and may indicate a time limit length, such as one day, one week, or some other time period. Sever 104 may then send the requested file to processing system 106-1 of the requesting user.

If server 104 determines that the requested file is not a copyrighted file (act 502), then server 104 may access a directory of shared files that may include a file name and an address of a processing device, for example, processing device 106-2 having access to the requested file (act 512). Server 104 may then pass the file name and address to processing device 106-1 (act 516), which may then establish a connection, such as for example, a P2P connection to processing device 106-2 of the sharing user. Processing device 106-1 of the requesting user may then request and receive the file from processing device 106-2 of the sharing user (act 518).

A copyrighted file with a time limit restriction loaded onto processing system 106-1 of the requesting user may be scrambled, encrypted, or deleted upon expiration of the time limit by, for example, application software executing on processing system 106-1, thereby making the file unusable to processing system 106-1 of the requesting user. In some implementations, the requesting user may pay for additional time before expiration of the time-limit in order to extend the time limit. In other implementations, the file may have a number-of-use limit instead of or in addition to a time-limit. For example, if the file is a music file, the file may be played a “number-of-use-limit” times on processing system 106-1 of the requesting user before the file is made unusable.

Implementations consistent with the principles of the invention may be used with a number of different types of files including, but not limited to music files, e-book files, e-zine files, multimedia files, such as for example, movies, and textual files.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Conclusion

Although the above description may contain specific details, it should not be construed as limiting the claims in any way. Other configurations of the described embodiments of the invention are part of the scope of this invention. For example, hardwired logic may be used in implementations instead of processors, or one or more application specific integrated circuits (ASICs) may be used in implementations consistent with the principles of the invention. Further, implementations consistent with the principles of the invention may perform more or fewer acts than as described, or may implement acts in a different order than as shown. Accordingly, the appended claims and their legal equivalents should only define the invention, rather than any specific examples given.

What is claimed is:

1. A machine-implemented method comprising:
receiving a request for a file;
determining whether the file is a copyrighted file;
determining a cost of the file;
determining whether a requesting user has a sufficient balance in at least one affinity group account to cover the cost of the file;
debiting the at least one affinity group account by an amount of the cost when the requesting user has the sufficient balance in the at least one affinity group account; and
sharing the requested file with a processing device associated with the requesting user.

2. The machine-implemented method of claim 1, wherein the acts of dete ring whether a requesting user has sufficient balance in at least one affinity group account to cover the cost of the file, and debiting the at least one affinity group by an amount of the cost are performed when the requested file is a copyrighted file.

3. The machine-implemented method of claim 1, further comprising:
denying access to the requested file when the requesting user is determined not to have a sufficient balance in the at least one affinity group account to cover the cost of the file and the requesting user is unwilling to pay.

4. The machine-implemented method of claim 1, wherein:
the act of determining whether a requesting user has a sufficient balance in at least one affinity group account to cover the cost of the file further comprises:
determining whether a combination of affinity group accounts has the sufficient balance to cover the cost of the file; and
the act of debiting the at least one of the affinity group accounts by an amount of the cost when the requesting user has the sufficient balance in the at least one affinity group account further comprises:
debiting the combination of affinity group accounts by the amount of the cost when the requesting user has the sufficient balance in the combination of affinity group accounts.

5. The machine-implemented method of claim 1, further comprising:
determining whether the requested file has a time limit restriction; and
inserting a time-limit indication into the requested file downloaded to the processing device associated with the requesting user.

6. The machine-implemented method of claim 1, further comprising:
determining whether the requested file has a number-of-use limit; and
inserting a number-of-use-indication into the requested file downloaded to the processing device associated with the requesting user.

7. The machine-implemented method of claim 1, wherein the requested file includes one of an audio file, an e-book file, a multimedia file, a textual file, or an e-zine file.

8. A machine-readable medium having instructions for a processor recorded thereon, the machine-readable medium comprising:
instructions for receiving a request for a file;
instructions for determining whether the file is a copyrighted file;
instructions for determining a cost of the file;
instructions for determining whether a requesting user has a sufficient balance in at least one affinity group account to cover the cost of the file;
instructions for debiting the at least one of the affinity group accounts by an amount of the cost when the requesting user has the sufficient balance in the at least one affinity group account; and
instructions for sharing the requested file with a processing device associated with the requesting user.

9. The machine-readable medium of claim 8, wherein the instructions for determining whether a requesting user has sufficient balance in at least one affinity group account to cover the cost of the file, and debiting the at least one of the affinity groups by an amount of the cost are executed when the requested file is a copyrighted file.

10. The machine-readable medium of claim 8, further comprising:
instructions for denying access to the requested file when the requesting user is determined not to have a sufficient balance in the at least one affinity group account to cover the cost of the file.

11. The machine-readable medium of claim 8, wherein:
the instructions for determining whether a requesting user has a sufficient balance in at least one affinity group account to cover the cost of the file further comprises:
instructions for determining whether a combination of affinity group accounts has the sufficient balance to cover the cost of the file; and
the instructions for debiting the at least one of the affinity group accounts by an amount of the cost when the requesting user has the sufficient balance in the at least one affinity group account further comprises:
instructions for debiting the combination of affinity group accounts by the amount of the cost when the requesting user has the sufficient balance in the combination of affinity group accounts.

12. The machine-readable medium of claim 8, further comprising:
instructions for determining whether the requested file has a time-limit restriction; and
instructions for inserting a time-limit indication into the requested file downloaded to the processing device associated with the requesting user.

13. The machine-readable medium of claim 8, further comprising:
instructions for determining whether the requested file has a number-of-use limit; and
instructions for inserting a number-of-use indication into the requested file downloaded to the processing device associated with the requesting user.

14. The machine-readable medium of claim 8, wherein the requested file includes one of an audio file, an e-book file, a multimedia file, a textual file, or an e-zine file.

15. An apparatus comprising:
a processor; and
storage for holding data and instructions for the processor, wherein the apparatus is configured to:
receive a request for a file,
determine whether the file is a copyrighted file,
determine a cost of the file,
determine whether a requesting user has a sufficient balance in at least one affinity group account to cover the cost of the file,
debit the at least one affinity group account by an amount of the cost when the requesting user has the sufficient balance in the at least one affinity group account, and
share the requested file with a processing device associated with the requesting user.

16. The apparatus of claim 15, wherein the apparatus is configured to determine whether a requesting user has sufficient balance in at least one affinity group account to cover the cost of the file, and debit the at least one affinity group account by an amount of the cost when the requested file is a copyrighted file.

17. The apparatus of claim 15, wherein the apparatus is further configured to:
deny access to the requested file when the requesting user is determined not to have a sufficient balance in the at least one affinity group account to cover the cost of the file.

18. The apparatus of claim 15, wherein:
when the apparatus determines whether a requesting user has a sufficient balance in at least one affinity group account to cover the cost of the file, the apparatus is further configured to:
determining whether a combination of affinity group accounts has the sufficient balance to cover the cost of the file, and
when the apparatus debits the at least one affinity group account by an amount of the cost when the requesting user has the sufficient balance in the at least one affinity group account, the apparatus is further configured to:
debit the combination of affinity group accounts by the amount of the cost when the requesting user has the sufficient balance in the combination of affinity group accounts.

19. The apparatus of claim 15, wherein the apparatus is further configured to:
determine whether the requested file has a time-limit restriction; and
insert a time-limit indication into the requested file downloaded to the processing device associated with the requesting user.

20. The apparatus of claim 15, wherein the apparatus is further configured to:
determine whether the requested file has a number-of-use restriction; and
insert a number-of-use indication into the requested file downloaded to the processing device associated with the requesting user.
